(19) United States
(12) Patent Application Publication
(10) Pub. No.: US 2003/0052928 A1
(43) Pub. Date: Mar. 20, 2003

(54) System for and method of interactive screen savers

(76) Inventor: Bruce G. Williams, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/953,000

(22) Filed: Sep. 14, 2001

(51) Int. Cl. G09G 5/00

(52) U.S. Cl. 345/867

(57) ABSTRACT

The present invention is directed to a system for and a method of enabling screen saver programs to establish a communications link to a remote server upon utilization. In addition, the present invention comprises, within the screen saver images, selectable portions, that when selected, connect the computer user to a corresponding internet site through a web server. This selection is typically performed through movement of a mouse or similar tracking device and selection of the selectable area.

### BACKGROUND

Typically, personal computer systems include screen savers which are displayed on the computer screen when the user does not interact with the keyboard or the pointing device for a specified amount of time to avoid the damage to the display caused by continuously displaying of a fixed image. Such screen savers can be enabled and controlled by the user through a screen saver control panel accessed while at the personal computer. Examples of screen savers include various graphics including a three-dimensional flower box, flying objects, mazes, pipes, text, simulated star field and other re-occurring patterns including digital photographs and images.

As mentioned, screen savers, as the name implies, have been implemented to prevent damage to the computer screen when a specific scene or display is displayed on a computer screen for excessive periods of time. In order to prevent permanent alteration of computer screens caused by this non-varying display, screen savers were created to display a varying pattern after the system detected inactivity for a pre-set period of time. For instance, after fifteen minutes, a screen saver could be initiated to vary the images displayed on a computer screen. Once initiated, the screen saver continues its display until a keyboard entry, mouse click or mouse movement is received. Once detected, the screen saver terminates and the computer system is returned to display its pre-screen saver characteristics or display.

Screen savers are typically non-interactive displays that terminate when user action is detected. This user action may consist of a depression of a key on the keyboard, mouse movement or a depression of a button on a mouse or similar device. A known screen saver is believed to allow the computer operator to update data that is processed by the screen saver software. This update is performed through an Internet connection.

### SUMMARY OF THE INVENTION

One embodiment of the present invention is directed to a system, including an interactive screen saver, comprising a remote server, and a computer having control over a screen saver program, the computer configured to initiate the screen saver program in response to a lack of user input for a predetermined period of time. The screen saver program is configured to display a screen saver image, having a selectable portion, and to establish a communication link with the remote server upon an initialization of the screen saver program.

Another embodiment of the present invention is directed to a method for advertising comprising the steps of displaying a screen saver image on a computer monitor the image including a selectable portion, said displaying initiated in response to a lack of user input for a predetermined period of time; receiving an input from a pointing device where a cursor associated with said pointing device is located on said selectable portion and a selected button is depressed which said cursor is so positioned; and connecting the computer displaying the screen saver image to a web site associated with said selectable portion, in response to received ones of said inputs.

A further embodiment of the present invention is directed to a method of connecting to a web server, the method comprising displaying a screen saver image on a computer monitor in response to a lack of user input for a predetermined period of time, including within the screen saver selectable images and associated web addresses, monitoring the selectable images for a selection, and responding to a selection by connecting the computer to the web address associated with the selection.

### BRIEF DESCRIPTION OF THE DRAWINGS

FIG. 1 is a representative computer system connected to a network on which the invention may be practiced;

FIG. 2 is a flow chart which illustrates exemplary functions of the screen saver program according to the present invention; and

FIG. 3 is a diagram schematically illustrating components within the screen saver system, according to an embodiment of the present invention, including the direction of information flow.

### DETAILED DESCRIPTION

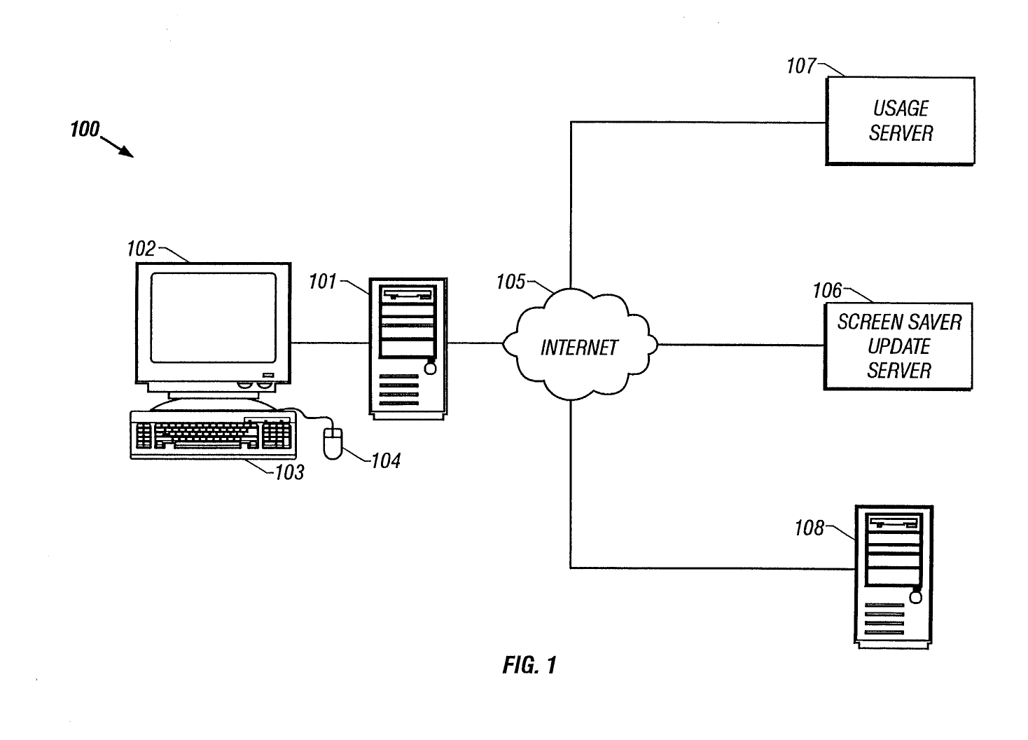

FIG. 1 shows system 100 in which a personal computer (PC) 101 is connected to computer display 102 or monitor. Also connected to PC 101 is keyboard 103 and mouse 104 or a similar pointing device. PC 101 may access Internet 105 through a network connection. Once PC 101 is connected to Internet 105, the computer operator may access numerous interconnected sites or web sites. Typically PC 101 includes screen saver software which is initiated if a key on keyboard 103 or the pointing device 104 is not moved or a button selected for a pre-determined period of time. This screen saver would be displayed on screen 102. Typically screen savers are static, in that the information displayed resides in a file on PC 101 and the information stored in that file is not regularly updated. Prior art screen savers can be updated through the introduction of a storage device, such as a diskette, tape, or similar storage media being introduced into PC 101 and a stored screen saver on the media device downloaded to PC 101.

Typically screen savers appear when the system has been inactive for a period of time and screen savers disappear when the user interacts with keyboard 103 or the pointing device 104. In system 100 of FIG. 1, when the screen saver image stored on PC 101 is displayed on screen 102, PC 101 connects over Internet 105 to screen saver update server 106. Once connected, PC 101 may receive a query from screen saver update server 106 requesting a list of screen saver images which are currently stored on PC 101. Alternatively, PC 101 may initiate communications by supplying screen saver update server 106 with, for example, a list of currently stored screen saver images.

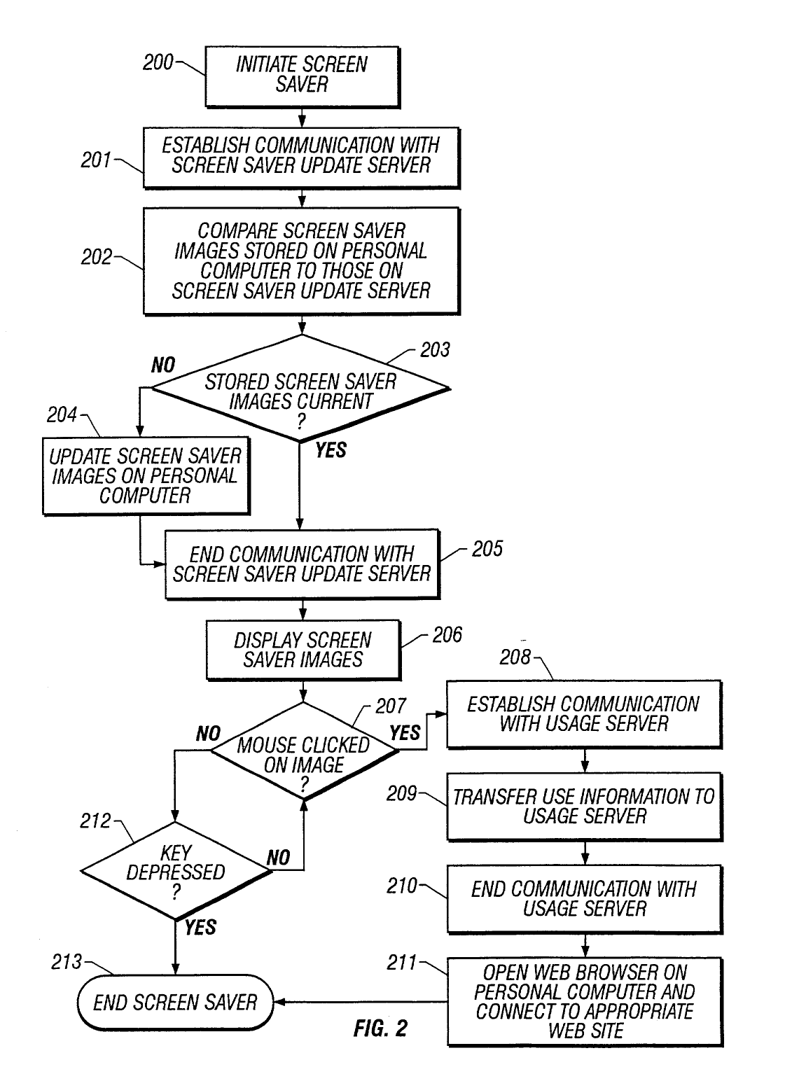

Referring now to FIG. 2, when the screen saver display routine is initiated in step 200 on screen 102 of FIG. 1 communication is established between PC 101 and screen saver update server 106 as shown in step 201. Once communication is established, step 202 compares screen saver images currently stored on PC 101 with screen saver images stored in screen saver update server 106. This may be initiated by PC 101 or screen saver update server 106. In step 203, screen saver update server 106 determines if the current screen saver images stored on PC 101 are current. If the screen saver images currently stored on PC 101 are not current, step 204 updates the screen saver images and associated web site addresses on PC 101 from the screen saver update server 106. This update may include the deletion of outdated or “stale” screen saver images. Once the stored screen saver images are current, communications with screen saver update server 106 are terminated in step 205 and the connection is dropped or session is terminated.

Once the screen saver images are updated on PC 101, or if the screen saver images did not require updating, PC 101 begins displaying screen saver images in step 206 on display 102 (FIG. 1) and waits for user interaction. Movement of the mouse causes movement of the cursor on screen 102 but will not terminate the screen saver program. If a selected mouse button is depressed and the cursor is located on a selectable portion of the screen, which is smaller than the entire screen, step 207 is answered in the affirmative and PC 101 establishes a connection with usage server 107 (FIG. 1) in step 208 and supplies information concerning the selected image and user information via Internet 105 in step 209. One or ordinary skill in the art would understand that multiple images could be displayed with each image containing a selectable portion of the screen. Alternatively, if one image is displayed, the system may be configured to allow selection of any point on the screen. Alternatively, user information may be prestored, through a registration process, and accessed by usage server 107 when required. This information may consist of user information including age, gender, occupation, hobbies, interests, marital status, etc. After the image selection and user information is transferred, the connection to usage server 107 is terminated in step 210.

Screen saver program initiates (spawns) a web browser window to connect PC 101 to the appropriate web site in step 211. Once PC 101 is connected to the appropriate web site, computer screen 102 displays the web site information and the screen saver program is terminated. Alternatively, if an image is not selected in step 207, PC 101 checks to see if a key from keyboard 103 has been depressed in step 212. Thus, PC 101 waits for an image to be selected with mouse 104 or for a key to be depressed while screen saver images are displayed on computer screen 102 (FIG. 1). Once a keyboard key is depressed in step 212, PC 101 returns display processing to the active or immediately previous application that was being displayed on display screen 102 prior to the display of a screen saver image in step 206. In either case, once display processing of PC 101 is returned to the previous application, or PC 101 connects to the appropriate web site, if no keyboard 103 entry or mouse 104 activity is detected for the preselected amount of time, the screen saver program in step 200 is again initiated. One of ordinary skill in the art would understand that the screen saver server tasks may be distributed over numerous processors or servers. For instance, a server or processor may be dedicated to management and storage of usage information with a second server or processor supporting centralized updating of screen saver images.

Returning to FIG. 1, as discussed with reference to FIG. 2, once the selected image has been identified, screen saver program resident on PC 101 connects PC 101 to the appropriate web site (associated with the selected image) through a web browser.

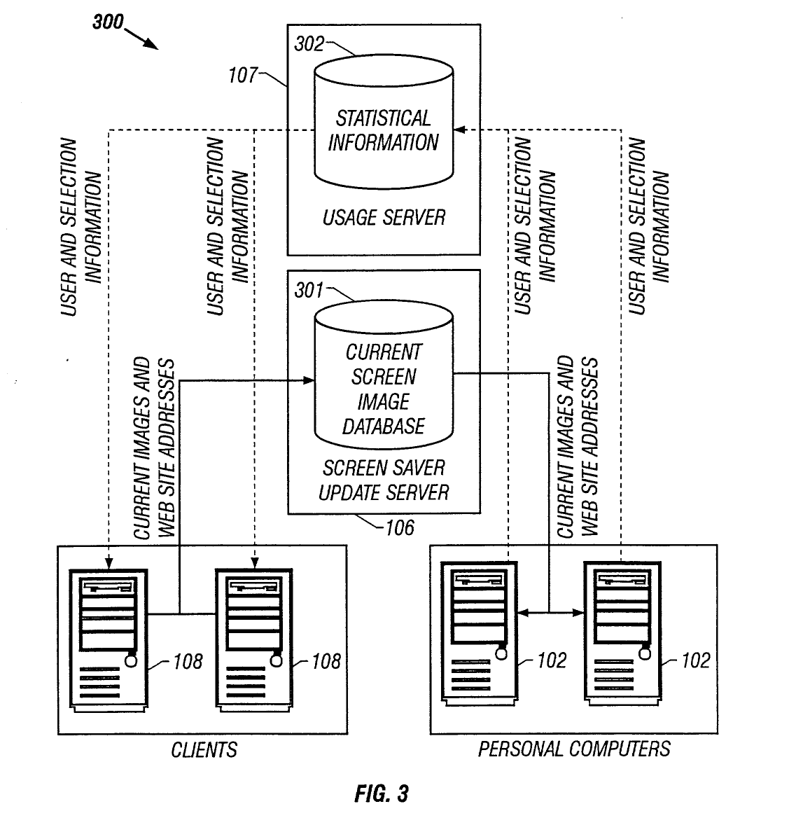

FIG. 3 shows an overall diagram of the screen saver update server and usage server's connection to client PCs and hosts. Clients 108 (FIGS. 1 and 3) connect to screen saver update server 106 to update the current screen saver images stored in the current screen saver image database 301. These connections allow manufacturers to update screen saver images used for advertising or other purposes through clients 108. Additionally, manufacturers may access use information through clients 108 by accessing statistical information database 302 resident on usage server 107.

Similarly, as described in FIG. 2, users of PCs 101 may access and update screen saver images from current screen saver image database 301. As previously described, statistical information is gathered from users selecting images and is stored in statistical information database 302. For instance, a manufacturer may wish to have a catalog of their products displayed on screen savers at various personal computers throughout the United States. This manufacturer may create a screen saver and associated web site addresses which prominently exhibit their products for display on the PCs of potential customers. These associated web addresses would be used by the screen saver program when the product is selected by the user. Additionally, as described with reference to FIG. 2, when the computer user positions pointing device 104 on the manufacturer's product on computer screen 102, and selects the image, the web address associated with the image is used to display the appropriate web page on the user's PC 101 by connecting PC 101 to the appropriate web site.

In another example, a user of PC 101 may desire to purchase a new home and may select screen savers to be displayed on screen 102 which show pictures of new houses available (or about to be available) on the market. A single screen saver can be configured to show multiple images of houses falling within the price range and location specified by the user, or screen savers can be configured so that each individual screen shows a selected house. In this case, when a user selects, or clicks, on an image of a specific house, they will be connected with a realtor's web site which lists additional information about the selected house.

Returning to FIG. 3, each time the user of PC 101 selects an image on a screen saver, usage server 107 gathers statistical information which is stored in statistical information database 302 of FIG. 3 for later processing. The processing performed on this information may be of several types. First, the statistical information may be used to help manufacturers market their products. For instance, if the occupation of the user is one of the parameters collected and tracked by usage server 107, a correlation may be made between the user's occupation and the web site visited or products of interest to the user. This may allow a manufacturer to identify occupations which are particularly interested in their product and market their product accordingly.

Additionally, computer users may be encouraged to view information from the screen savers by the institution of a lottery system or similar reward program sponsored by the entity which distributes the screen saver program. In one embodiment, each time the user designates a selectable portion of the screen saver, their name or other identifying information is entered into a contestant's database in which, periodically, an individual is selected for a prize. This system can be used as an incentive or motivation for the user to view information associated with the screen savers downloaded to their computer. Screen saver programs may be distributed to users through the mail, giveaways at local retailers or downloaded from the Internet. Also, when the screen saver comes up, it can be directed to cause a logon to the remote server for the purpose of downloading sports scores, new, stock prices, sales events, or simply upcoming events such as movies (and times), plays, or concerts.

What is claimed is:

1. A system including an interactive screen saver comprising:
a remote server; and
a computer having control over a screen saver program, said computer configured to initiate said screen saver program in response to a lack of user input for a predetermined period of time, said screen saver program configured to:
display a screen saver image, having a selectable portion, and
establish a communication link with said remote server upon an initialization of said screen saver program.

2. The system of claim 1 wherein said screen saver program is configured to transmit information to said server upon selection of said selectable portion of said screen saver image.

3. The system of claim 2 wherein said transmitted information pertaining to said selectable portion of screen saver images.

4. The system of claim 1 wherein said selectable portion of said screen saver image is affiliated with a website.

5. The system of claim 1 wherein said communication link is at least a portion of an internet.

6. The system of claim 1 wherein said computer includes a keyboard and wherein a depression of a key on said keyboard terminates an initiated screen saver program.

7. The system of claim 1 wherein said computer includes a pointing device and wherein a movement of said pointing device does not terminate an initiated screen saver program.

8. A method of advertising, said method comprising the steps of:
displaying a screen saver image on a computer monitor said image with a selectable portion, said displaying initiated in response to a lack of user input for a predetermined period of time;
receiving an input from a pointing device where a cursor associated with said pointing device is located on said selectable portion and a selected button is depressed which said cursor is so positioned; and
connecting said computer displaying said screen saver image to a web site associated with said selectable portion, in response to received ones of said inputs.

9. The method of claim 8 further comprising the step of:
updating certain portions of said displayed image from information sent from said connected web site.

10. The method of claim 8 further comprising the steps of:
recording identifying information in response to receiving said input.

11. The method of claim 8 wherein said screen saver image is displayed by a screen saver program.

12. The method of claim 8 further comprising:
updating at least a portion of said screen saver image from a connection with said web site.

13. The method of claim 8 wherein a screen saver program is terminated when a key depression is received from a keyboard.

14. The method of claim 8 wherein said images are stored in a database and wherein said database is accessible by a server at said connected web site.

15. The method of claim 14 wherein said server can be accessed by a client and wherein said access is used to update at least a portion of said images on said database.

16. A method of connecting to a web server, said method comprising the steps of:
displaying a screen saver image on a computer monitor in response to a lack of user input for a predetermined period of time;
including within said screen saver selectable images and associated web addresses;
monitoring said selectable images for a selection; and
responding to a selection by connecting said computer to the web address associated with said selection.

17. The method of claim 16 further comprising the step of:
communicating information corresponding to said selection of said selectable image via electronic means to said associated web address.

18. The method of claim 16 further comprising the step of:
updating a database of said screen saver images, said updating occurring which said computer is connected to said web address.

19. The method of claim 16 further comprising the steps of:
tracking the number of selections of selectable images identified; and
correlating the number of selections to a number of entries in a giveaway program.

20. The method of claim 16 further comprising the steps of:
storing user specific information in a statistical database; and
targeting marketing by using said specific information.
